(19) United States
(12) Patent Application Publication
(10) Pub. No.: US 2024/0375620 A1
(43) Pub. Date: Nov. 14, 2024

(54) VEHICLE WASH SYSTEM

(71) Applicant: Amanda R. DeYulis, Hollidaysburg, PA (US)

(72) Inventor: Amanda R. DeYulis, Hollidaysburg, PA (US)

(21) Appl. No.: 18/662,467

(22) Filed: May 13, 2024

Related U.S. Application Data
(60) Provisional application No. 63/466,013, filed on May 12, 2023.
(60) Provisional application No. 63/525,469, filed on Jul. 7, 2023.

(51) Int. Cl. B60S 3/04; B08B 1/12; B08B 1/40; B08B 3/02; E04H 6/02

(52) U.S. Cl. CPC B60S 3/04; B08B 1/12; B08B 1/40; B08B 3/024; B60S 3/042; E04H 6/02

(57) ABSTRACT

A car wash system that may be stored or installed in a residential or commercial building, such as a garage in a home or car dealership, respectively. The system may include wash units that are attachable to a guide such as a track attachable to a ceiling or wall of the garage, a raised rail or inset groove on a floor of the garage, or both. The guide may be arranged inside of the garage and may extend outside of the garage temporarily or permanently. The system may have a closed configuration for storage inside the garage and an open configuration for washing the vehicle either inside or outside of the garage. Transitions from the open to closed configurations and vice versa may be automatic, such as controlled by a control panel or handheld device.

### CROSS-REFERENCE TO RELATED APPLICATIONS

This application claims priority to and the benefit of U.S. Provisional Patent Application No. 63/525,469 filed Jul. 7, 2023, and U.S. Provisional Patent Application No. 63/466,013 filed May 12, 2023, the entire contents of which are incorporated by reference herein.

### TECHNICAL FIELD

This invention relates to a wash system for a vehicle for use in a residential or commercial building, such as a garage.

### BACKGROUND

During normal operation, most vehicles are exposed to various environmental elements such as dust, dirt, mud, pollen, bird droppings, tree sap, road salt and other chemicals used to melt ice and snow, all of which can accumulate on the surface and cause damage over time. Regular washing helps to remove these contaminants, preventing damage to the paint and corrosion of the metal parts of the vehicle, as well as helping to keep the interior clean by preventing dirt and grime from being tracked inside. Moreover, a dirty car can reduce visibility, especially during rainy or foggy weather. Regular washing helps to maintain clear windows and mirrors, ensuring visibility for the driver while operating the vehicle.

Automatic drive-through wash facilities are well known, such as the traditional tunnel, conveyor-type car wash facilities common in the industry. While such facilities are a huge convenience over washing a vehicle by hand, such facilities are not always available or conveniently located and can present a range of potential problems for the vehicle owner, especially when used in colder climates. For example, in areas where the temperature drops below freezing, water can freeze on the car's surface and cause damage to the paint. Commercial car washes that use high-pressure water and air drying can exacerbate this problem, as the water and air can penetrate cracks and crevices in the paint and freeze, causing the paint to chip or crack. Water from such car washes can also penetrate car locks, door seals, and outside mirror mechanisms, preventing the driver from opening the car door or use of important safety equipment while operating the vehicle.

Thus, there remains a need for an improved vehicle wash system that provides effective cleaning of vehicle surfaces in a convenient, cost-effective manner.

### SUMMARY

The invention of the present disclosure meets this need by providing a car wash system that may be used in, or installed in, a residential or commercial building, such as a garage, and used either in the garage to wash a vehicle or extended to a position outside of the garage to wash the vehicle.

The system may include a guide such as a track mounted to a ceiling or wall of the garage, a raised rail or inset groove on a floor of the garage, or both. The guide may be arranged inside of the garage and may extend outside of the garage temporarily or permanently. The system may include a frame having at least four vertical posts supporting an upper frame, each vertical post comprising a bottom end having a wheel and a top end attached to and supporting the upper frame. The system may include a frame that includes a series of inverted U-shaped rails connected along each leg of the rail via a substantially horizontally positioned connecting rail. The connecting rail may include an articulated arm that may be compressed to allow the system to attain a closed, compressed state and an open, extended state.

The system may include wash apparatus that are part of the track or frame, or that are attachable to the track or frame. The system may include wash units that are part of the track or frame, or that are attachable to the track or frame. Exemplary wash apparatus include one or more of spray nozzles, flexible hoses, and articulated pipes, wherein the spray nozzles and/or articulated pipes may include one or more spray nozzles, such as at a distal end or along a longitudinal length thereof.

The wash units may be moveably attached to the system, such as along the track or frame. The wash units may have an active and a passive position. The wash apparatus may have an extended and/or retracted position.

The system may comprise a closed configuration for storage inside the garage and an open configuration for washing the vehicle either inside or outside of the garage. Transitions from the open to closed configurations and vice versa may be manual, or may be automatic, such as from a control device or panel.

The system may include attachments useful for washing specific components of the vehicle, such as an underbody sprayer and/or wheel and rim scrubber.

The system may provide touchless cleaning of the vehicle.

The system may be sized and configured to accommodate several differently sized vehicles such as, for example, cars, trucks, vans, motor homes or RVs, boats, motorcycles, ski-doos, and all-terrain vehicles.

The present disclosure also provides methods of use of the car wash system.

Other aspects, features, benefits, and details of the present invention can be more completely understood by reference to the following detailed description of the preferred embodiments, taken in conjunction with the drawings and from the appended claims.

### BRIEF DESCRIPTION OF THE DRAWINGS

In the following figures, like numerals represent like features in the various views. It is to be noted that features and components in these drawings, illustrating the views of embodiments of the present invention, unless stated to be otherwise, are not necessarily drawn to scale.

FIG. 1 illustrates a car wash system according to aspects of the present disclosure installed within a garage, wherein wash hoses of two wash units of the system are in a retracted position.

FIG. 2 illustrates the car wash of FIG. 1, wherein the wash hoses are in an extended position to wash the car inside of the garage.

FIG. 3 illustrates the car wash of FIG. 1, wherein the wash hoses are in an extended position to wash the car outside of the garage.

FIG. 4 illustrates the car wash of FIG. 1, wherein the wash units are extended to a position outside of the garage to wash the car outside of the garage.

FIGS. 5A-5C illustrate attachments according to aspects of the present disclosure that are connectable to the wash hoses of the car wash system of FIG. 1, wherein FIG. 5A illustrates an exemplary underbody car wash sprayer and FIGS. 5B and 5C illustrate exemplary wheel and rim scrubbers.

FIG. 6 illustrates another car wash system according to aspects of the present disclosure installed within a garage.

FIG. 7 illustrates yet another car wash system according to aspects of the present disclosure installed within a garage.

### DETAILED DESCRIPTION

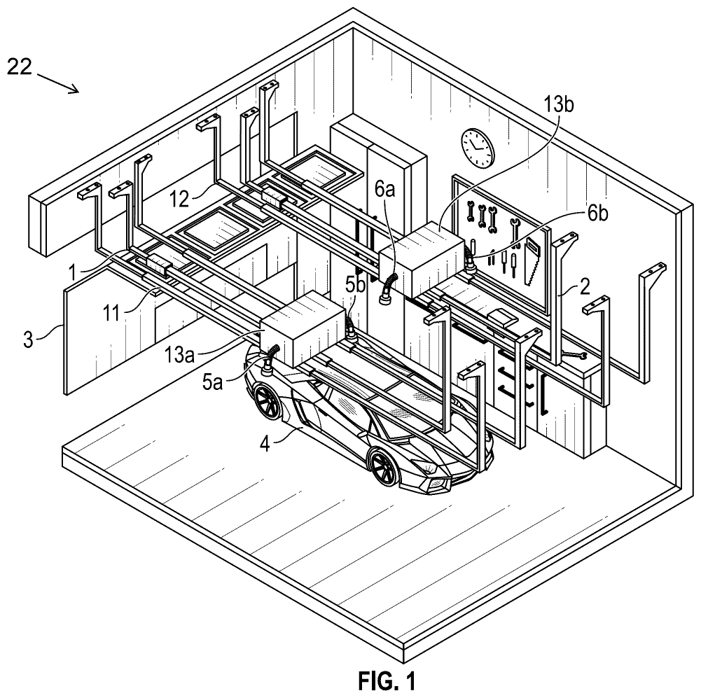

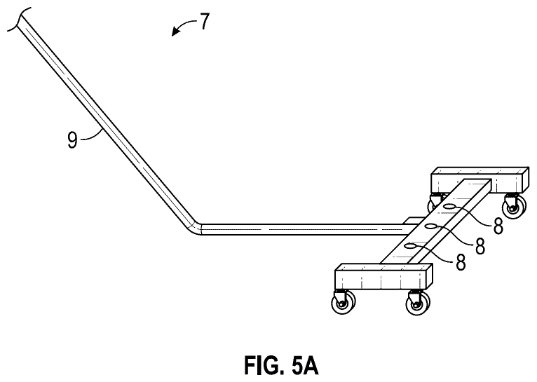

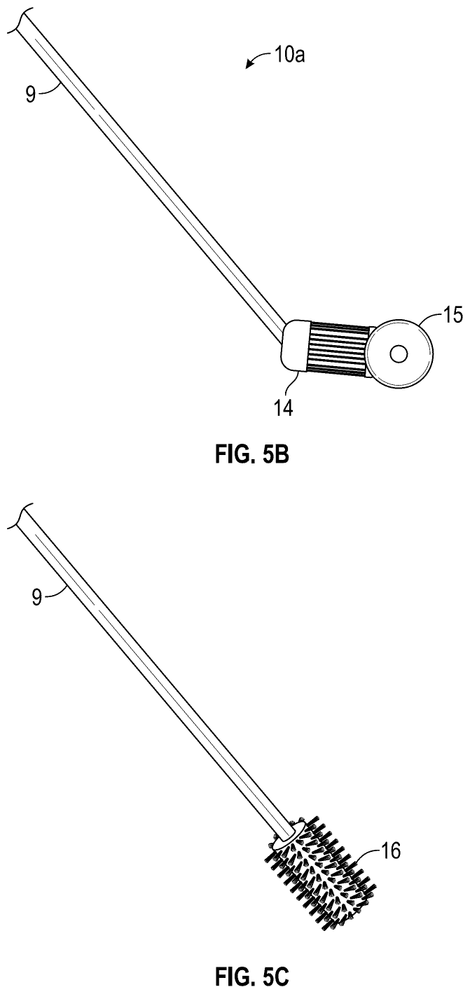

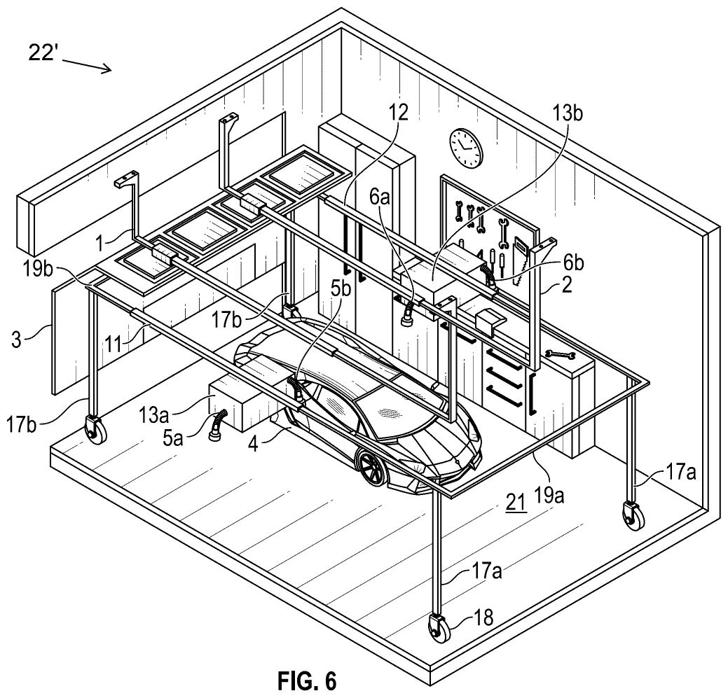

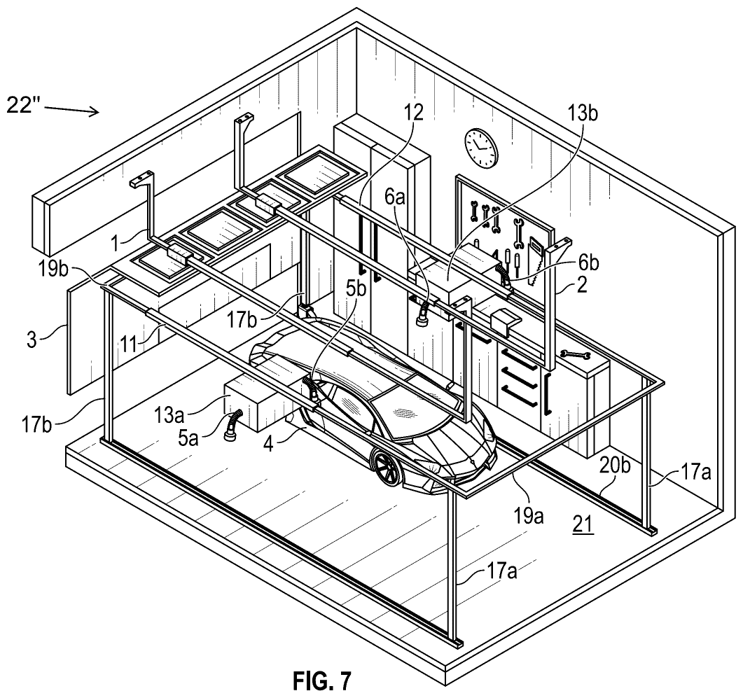

The present disclosure provides car wash systems for use in a residential or commercial building and methods of use of the car wash systems. A first implementation of the car wash system is shown in FIGS. 1-4, and exemplary attachment components useable with the system are illustrated in FIGS. 5A-5C. Second and third implementations of the car wash system are shown in FIGS. 6 and 7, respectively. While specific implementations of the systems and methods are shown and described in more detail hereinbelow, it should be appreciated by those skilled in the art that various modifications, alternations, and applications could be developed considering the overall teachings of the disclosure. Accordingly, the particular arrangements, systems, apparatuses, and methods disclosed herein are meant to be illustrative only and not limiting as to the scope of the invention.

The systems disclosed herein may be used in any residential or commercial building, such as in a garage or other area where a vehicle may be parked. For example, the systems may be used in a garage of a home or a garage of a car dealership. Other exemplary commercial buildings could include any building providing repair, painting, or detailing of a vehicle, or storage of a vehicle. Exemplary vehicles that may be cleaned using the systems and methods disclosed herein include at least cars, trucks, vans, motor homes or RVs, boats, motorcycles, ski-doos, all-terrain vehicles, tractors, ride-on lawn mowers, and the like. While the systems may be installed in any residential or commercial building and may be used to wash any vehicle, for simplicity of the following description, the systems will be described and illustrated as installed in a residential garage and used to wash a car.

In various implementations, the system may include one track, two tracks, one set of tracks, two sets of tracks, etc., wherein the track(s) are attachable to an interior surface of the garage, such as a wall, ceiling, floor, or any combination thereof. For example, the track(s) may be attached along a front and/or back wall of the garage, to one or more side walls of the garage, to a ceiling of the garage, on a floor of the garage, or any combination thereof. The track(s) may support one or more wash apparatus, such as spray nozzles, wash hoses, extensible articulated wash pipes, or the like. When included, the wash hoses or pipes may include a spray nozzle at a distal end thereof and/or spray nozzles positioned along a length of the wash hose or pipe.

The wash apparatus may be a permanent part of the track(s) or may be removably connected to the track(s), such as via a quick connect. The wash apparatus may extend from a storage compartment attached to the track(s), such as flexible hoses or articulated pipes that extend from and retract into the storage compartment.

The wash apparatus may extend directly from the track(s), wherein the water, cleaning products, and/or finishing agents may be supplied from a tank or series of tanks positioned on a floor or wall of the garage, and/or from a central line, such as a hose or water faucet. In this implementation, a supply line may extend from the tank or central line, e.g., faucet, to a connection point at a proximal end of each wash apparatus or a proximal end of one or more of the tracks. For example, the track(s) may have a connection element that provides connection to the supply line, wherein each of the tracks may include internal piping that provides fluid connection between the supply line and each of the wash apparatus.

Alternatively, the wash apparatus may extend from a wash unit. Exemplary wash units include tanks or reservoirs that may hold the water and/or cleaning products (e.g., soaps) and/or finishing agents (e.g., waxes, polishes), wherein the wash units are permanently or removably attached to the track(s).

As used herein, “cleaning fluid” shall be understood to encompass one or more of (i) water, (ii) cleaning product(s) such as soap, (iii) finishing agents such as waxes or polishes. The agents may be supplied to the system as solids or liquids, wherein solid agents may be mixed with water or another fluid prior to dispensing on the car. Mixing may be accomplished at the wash apparatus, i.e., within the wash hoses or pipes, or within the wash unit. Mixing of the solids or liquids, such as concentrated cleaning agents and water, may by via another mixing device positioned prior to the wash units, rails, mail connection line(s), etc. The cleaning fluids may be stored in separate containers and may be mixed as appropriate and as described above.

Many garage doors include rollers attached along edges of the door that move within tracks that are positioned along sides of the garage door opening and ceiling of the garage. As such, when the wash system includes two tracks, each track may be positioned on an inside of the garage door tracks, i.e., toward the lateral center of the garage, wherein the longitudinal direction is from the front of the garage, i.e., at the garage door, to the back wall of the garage, i.e., wall opposite the garage door. Alternatively, each track may be positioned on an outside of the garage door tracks, i.e., away from the lateral center of the garage. Each track may be positioned so that the car wash system does not interfere with operation of the garage door. For example, each track may be individually positioned vertically above or below the position of the garage door tracks.

When sets of tracks are used, both tracks of each set of tracks may be positioned on an inside of the garage door tracks or on an outside of the garage door tracks. Alternatively, the tracks of a set of tracks may be positioned on either side of the garage door tracks. Moreover, each track of the set of tracks may be individually positioned so that the car wash system does not interfere with operation of the garage door. That is, each track may be individually positioned vertically above or below the position of the garage door tracks so that the car wash system does not interfere with operation of the garage door. For example, an inner track of the set of tracks (i.e., track positioned toward the center of the garage) may be positioned above the garage door track and an outer track of the set of tracks may be positioned below the garage door track. Alternatively, only the inner track may be positioned above or below the garage door track and the outer track may be positioned at the same level as the garage door track. Further, each track of the set of tracks may be attached to the ceiling, front wall, and/or back wall of the garage, or the inner track may be attached to the ceiling, front wall, and/or back wall of the garage and the outer track may be attached to the ceiling, front wall, back wall, and/or side wall of the garage.

A specific implementation of the car wash system 22 is illustrated in FIG. 1, wherein the system comprises two sets of tracks (11, 12) that are attached to a ceiling of the garage, such as via each end of the track(s). Each set of tracks is spaced apart laterally within the garage, such as at a position in-line with respective edges of a garage door. As shown, each track of the set of tracks is positioned on either side of a garage door track (1, 2) such that they do not interfere with operation of the garage door 3. i.e., opening or closing.

Attachable to each track (11, 12) is at least one wash unit (13a, 13b). The wash unit may contain cleaning fluids. The wash unit may be configured to move along a longitudinal length of the track(s) or may be stationary on the track. Each wash unit (13a, 13b) may comprise one or more spray nozzles to dispense the cleaning fluid(s). In certain configurations, each wash unit may include one or more wash apparatus, such as one or more wash hoses or pipes. As shown in FIG. 1, each wash unit comprises a wash hose on each side thereof (5a, 5b, 6a, 6b).

When the wash units include wash apparatus, e.g., flexible wash hoses or articulated pipes, the hoses or pipes may have nozzles at a distal end to dispense the cleaning fluid(s), such as shown in the figures. Alternatively, the wash hoses or pipes may include nozzles along a longitudinal length so that the cleaning fluid(s) is dispensed from a side of the hose, such as a side positioned inward to face the car. Such nozzles may be included along a full longitudinal length of the wash hose or pipe, or on only a portion thereof, such as near an end of the wash hose or pipe. In this latter case, the wash hose or pipe may be extended to position the nozzles adjacent the car to provide maximal coverage of the cleaning fluid on the car.

The wash apparatus may be flexible hoses, such as shown in the figures, or may be lengths of articulated piping, wherein each section of the piping is inflexible. When the wash apparatus are articulated wash pipes, they may be placed in a specific static position, such that the nozzles may be optimally positioned to provide the cleaning solution to the car exterior. For example, each of the joints of the articulated piping may be lockable to a specific position. A similar ability is possible for the flexible hoses, such as with extendible and collapsible pressure hoses, or telescoping hoses, or retractable hoses, wherein the hoses may be rotated to position any longitudinally placed nozzles facing inward toward the car.

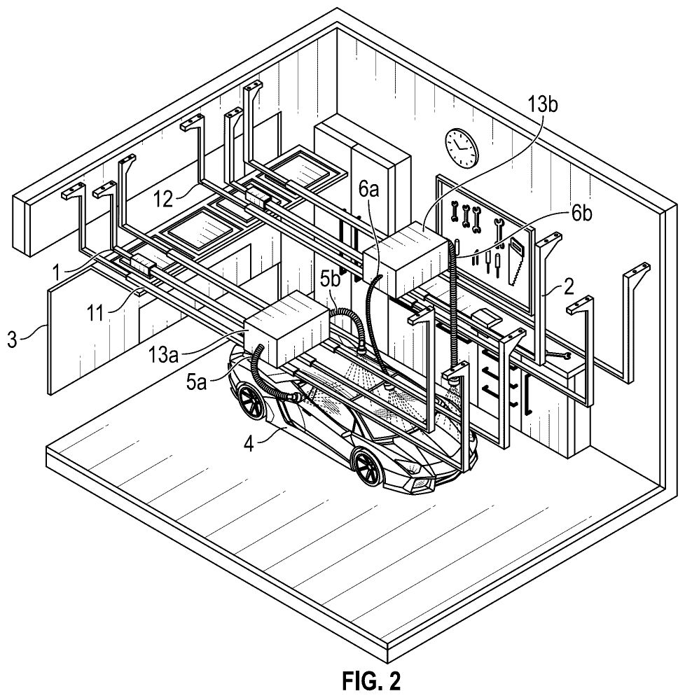

The wash apparatus may have a retracted position, such as when not in use as shown in FIG. 1, and an extended position, such as when the system is in use to wash a car 4 as shown in FIG. 2.

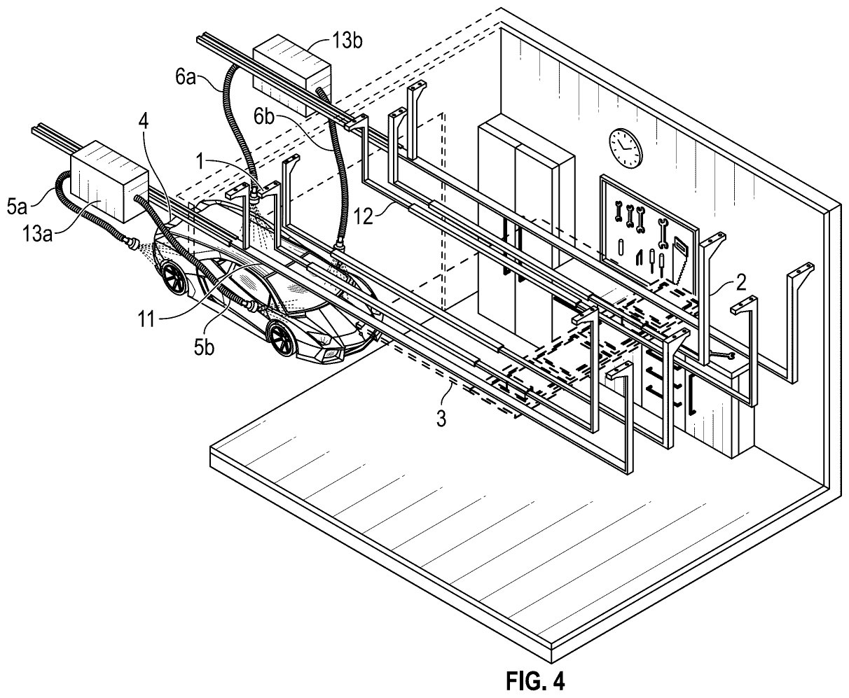

According to certain aspects, the tracks (11, 12) of the system may be configured to extend to a position outside of the garage, as shown in FIG. 4. For example, the tracks may include a portion that telescopes outward. The wash units (13a, 13b) may then be moved along the track(s) to a position outside of the garage, such as to wash a car parked outside of the garage.

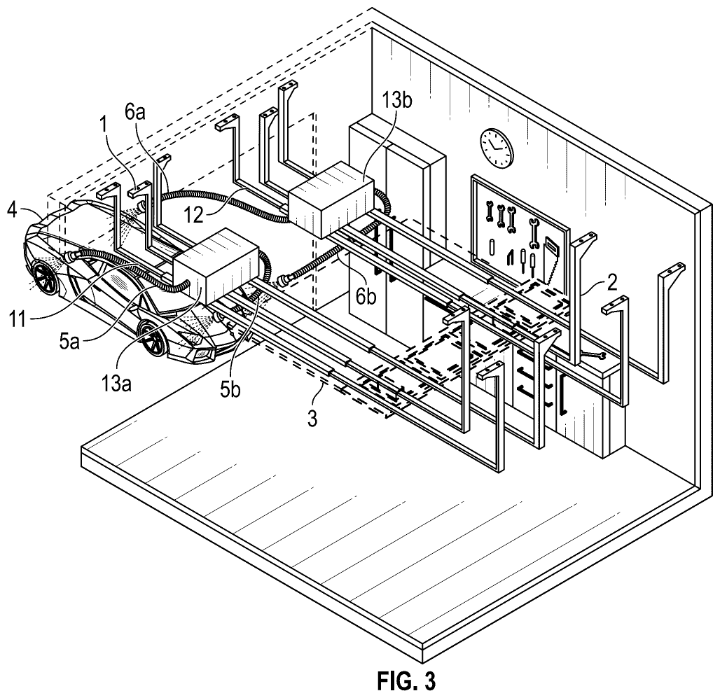

The wash units may be positionable on a top side of the track, such as shown in FIG. 3, or along a side of the track, such as shown in FIG. 4, or along a bottom of the track, such as shown in FIG. 6, as long as the wash units do not interfere with operation of a garage door. The wash units may be moveable from one position to another, such as from a stored position to an operable position. As example, the wash units may have a stored position on a top of the rail, and an operable position on a side or bottom of the rail.

The system may be configured to extend and retract the tracks, move the wash units along the track, and/or extend or retract the wash apparatus automatically or manually. For example, the user may pull or push the wash units along the track to a desired position, such as via a tow line or may be moved using a pole attachable to a connection on the wash units. The user may then pull the wash apparatus, e.g., wash hoses, downward for use to wash the car. i.e., spray the cleaning fluid on the car, wherein nozzles on the wash apparatus may be operable to change the outlet size and thus the cleaning fluid spray diameter and pressure. When washing is complete, the user may push the wash apparatus to the retracted position or engage a spring-loaded mechanism that causes the wash apparatus to retract.

For automatic operation, the system may include a control unit and a user access device that may be used to initiate various actions of the system. The user access device can be a handheld controller that communicates with the control unit wirelessly or via a wired connection, or an access panel attachable to a wall of the garage. The actions controllable by the control unit may include turning the system on or off, extending and retracting the tracks, extending and retracting the wash units and/or wash apparatus, and controlling how far the wash units and/or wash apparatus are extended or retracted, starting or stopping dispense of the cleaning fluid, and the like.

As example, and with reference to FIG. 3, the wash units (13a, 13b) may be moved manually or automatically to a position adjacent the garage door 3 so that the wash hoses (5a, 5b, 6a, 6b) may be extended manually or automatically using the control system to positions outside of the garage to wash the car 4 parked outside of the garage. With reference to FIG. 4, the tracks (11, 12) may extend to a position outside of the garage, and the wash units (13a, 13b) may move along the tracks to a position outside of the garage to wash the car 4 parked outside of the garage, wherein either movement may be performed manually and/or automatically using the control system. Such an arrangement may provide for use of the system outside of the garage, such as in situations when there is no drainage, or sufficient drainage, within the garage.

The wash units (13a, 13b) may move along the tracks (11, 12) using bobbins at each end of the track or with on-board motorization. The advantage of the latter deployment is that all torque is applied to the wash unit, such as to wheels of the wash unit, and small deviations in the torque of the motor can easily be compensated with additional non-powered wheels. The wash units may include a motor within the main body, or two or more of the wheels may be a direct drive wheel. The wash unit, if motorized, may include a limit switch or proximity sensor at each end thereof that causes the wash unit to sense and end of the track and change directions. Various other embodiments of this geometry may be actuated at both ends, such as two bobbins alternatively rolling/unrolling a flexible ribbon (or conveyor belts or transmission chains), or a motorized tubing having attached thereon the wash apparatus. Different motors may be used to actuate the cart, such as AC, DC or steppers.

Weights may be attached to the wash apparatus, if needed, to pull the wash apparatus to a fully extended state. For example, ends of flexible hoses may include a weight to pull the hose to its fully extended state. Such weights, however, would not interfere with any mechanisms provided to recoil the flexible hoses.

In some embodiments, the wash system may comprise tracks that are fully mobile and independent of the garage. For example, the wash system may comprise a frame having two or more inverted U-shaped rails, i.e., two vertically oriented legs supporting an overhead structure. The overhead stricture may be curved or be formed at right angles from the legs. The inverted U-shaped rails are connected to each other, such as via connecting rails attached along each of the vertically positioned legs of the U-shaped rails. In some implementations, the connecting rails may be flexible or bendable, e.g., foldable. Thus, when the connecting rails are extended, the frame may form a tunnel sized and configured to accommodate a car. The U-shaped rails may each include nozzles positioned on an inward facing surface, such as several nozzles spaced apart along the rails and aimed at a car when the wash system is positioned over the car. In such an implementation, the wash apparatus may comprise hoses or pipes positioned within an inner bore of the U-shaped rails. These hoses or pipes may be connected to a main connection line, such as a flexible hose or articulated pipe that runs substantially horizontally along a longitudinal length of the wash system (i.e., when in an extended position).

The main connection line may include a connection at a distal end thereof, such as proximate a final inverted U-shaped rail of the wash system. The distal end of the main connection line may include a threaded connection element or quick connect providing connection to a tank positioned on a floor or wall of the garage and/or a central supply line, such as a hose or water faucet. In this implementation, a supply line may extend from the tank and/or central supply line, e.g., faucet, to the distal connection point of the main connection line. As noted above, the cleaning fluids may be stored in the tank or may be stored in separate containers and may be mixed as appropriate in the main connection line or another mixing device positioned prior to the main connection line.

In certain implementations, the wash system may include wash units connected to the U-shaped rails, such as along the two vertically oriented legs or the overhead structure. The wash units may move along the vertically oriented legs and/or the overhead structure. Moreover, the wash units may be positioned statically on the vertically oriented legs and/or the overhead structure, such as one or more wash units positioned on each overhead structure that are spaced apart when the frame is extended to form the tunnel. The wash units may contain cleaning fluids and may comprise one or more nozzles to dispense the cleaning fluid(s). In certain configurations, each wash unit may include one or more wash apparatus, such as extending from a bottom surface of the wash unit, or sides of the wash unit (e.g., as shown in FIG. 1).

When the wash units include wash apparatus, such as wash hoses or pipes, the wash apparatus may have spray nozzles at a distal end to dispense the cleaning fluid(s). Alternatively, the wash apparatus may include nozzles along a longitudinal length so that the cleaning fluid(s) is dispensed from a side of the hose, such as a side positioned inward to face the car. Such nozzles may be included along a full longitudinal length of the wash apparatus, or on only a portion thereof, such as near an end of the wash apparatus. In this latter case, the wash apparatus may be extended to position the nozzles adjacent the car to provide maximal coverage of the cleaning fluid on the car.

The wash apparatus may be flexible or articulated hoses, such as shown in the figures, or may be lengths of articulated piping, wherein each section of the piping is inflexible. As discussed above, when the wash apparatus are articulated, they may be placed in a specific static position, such that the nozzles may be optimally positioned to provide the cleaning solution to the car exterior.

In another implementation, the wash system 22′ may comprise a frame having at least four vertically oriented legs supporting an upper frame, such as one having a generally rectangular shape. One or more wash units may be moveably connected to the upper frame and configured to provide a wash fluid directed inward from opposing vertical sides of the frame. With reference to FIG. 6, an implementation of a wash system 22′ includes a set of front legs 17b and a set of back legs 17a, wherein distal ends of each leg may include a wheel 18 configured to provide movement for the wash system on a surface, such as a floor 21 of the garage, a driveway, and the like. A proximal end of each leg may be connected to an upper frame. As shown in FIG. 6, the upper frame includes longitudinal tracks (11′, 12′) and lateral connections rails (19a, 19b), wherein respective ends of the longitudinal tracks (11′, 12′) are connected to respective ends of the lateral connection rails (19a, 19b) to form a generally rectangular upper frame.

Attachable to each longitudinal track (11′, 12′) is at least one wash unit (13a, 13b). As disclosed hereinabove, each wash unit may contain cleaning fluids, and may be configured to move along a longitudinal length of the track(s) or may be stationary on the track(s). Each wash unit (13a, 13b) may comprise one or more nozzles to dispense the cleaning fluid(s). In certain configurations, each wash unit may include one or more wash apparatus. As shown in FIG. 6, each wash unit comprises a wash hose on each side thereof (Sa, 5b, 6a, 6b). Moreover, while illustrated as comprising a single longitudinal track (11′, 12′) on each side of the wash unit, sets of longitudinal tracks could be included, such as shown in FIG. 1.

Each of the front legs 17b and back legs 17a of the wash system 22′ may be extendable to adjust a height of the wash system relative to a ground surface. Moreover, each of the longitudinal tracks (11′, 12′) may be extendable to adjust a length of the wash system, and each of the lateral connections rails (19a, 19b) may be extendable to adjust a width of the wash system. Such adjustment may accommodate vehicles of different heights, lengths, and/or widths, and/or may provide for use in a range of different building spaces (e.g., residential versus commercial garages).

In these latter embodiments, the entire system may be stored in a compressed state in a back of the garage and may be opened or extended within the garage to wash the car therein. The vertically oriented legs may include wheels 18, such as at ends distal from the upper structure or upper frame so that the system may be easily extended or compressed. The wheels may be free moving such that the system 22′ may be moved outside of the garage in either the compressed or extended state and may be used to wash the car outside of the garage in the extended state. As shown in FIG. 7, the wheels or ends of the front and back legs (17b, 17a, respectively) may be configured to operate within grooves or rails (20a, 20b) positioned on a floor 21 of the garage, which may extend to a position outside of the garage so the wash system 22″ may be moved to a position outside of the garage for washing the car.

The frame of wash system 22′ or 22″ may include material that covers all or a portion thereof or may include material panels connected between elements of the frame, i.e., sides and/or top of the frame, such that cleaning fluid dispensed to wash the car may be contained within the frame. The rails of the configurations shown in FIGS. 1-4 may include material that extends downward to contain the cleaning fluid substantially within the area of the car.

The system may provide fluids for washing the car in a touchless manner, such that no friction is used on at least the painted portions of the car during the washing process, i.e., a touchless carwash. All or some of the wash units may include a cloth, brush, or other physical element that is intended to contact at least the painted regions of the car to provide a friction carwash.

The system may include additional components, such as components attachable to the wash units. For example, as shown in FIG. 5A, the system may include an underbody sprayer 7 configured to be positioned under a car and dispense cleaning fluid upward to clean the undercarriage of the car, such as from spray nozzles 8. The underbody sprayer 7 may be attachable via a quick connect attachment 9 to an end of any one of the spray nozzles (e.g., 5a, 5b, 6a, 6b). Additional components may include brushes to wash the rims and wheels of the car, such as the circular brush 15 that is driven by a motor 14 shown in FIG. 5B. The brush/motor (14, 15) may be attached to a distal end of an inflexible pipe, wherein a proximal end of the pipe may be attachable via a quick connect attachment 9 to an end of any one of the wash apparatus, such as the wash hoses (5a, 5b, 6a, 6b) shown in the figures. In some embodiments, the force of the cleaning fluid may cause the circular brush to rotate. Shown in FIG. 5C is a scrub brush attachment comprising a brush 16 attached to a distal end of an inflexible pipe, wherein a proximal end of the pipe may be attachable via a quick connect attachment 9 to an end of any one of the wash apparatus.

Various aspects of the wash apparatus, systems, and methods disclosed herein have be illustrated with reference to one or more exemplary implementations or embodiments. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to.”

Various aspects of the wash apparatus, systems, and methods disclosed herein have been illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled”, “directly attached,” and/or “directly joined” to another component, there are no intervening elements shown in said examples.

Relative terms such as “lower” or “bottom” and “upper” or “top” have been used herein to describe one element's relationship to another element illustrated in the drawings. It will be understood that relative terms are intended to encompass different orientations of aspects of the support brackets in addition to the orientation depicted in the drawings. By way of example, if aspects of the support brackets shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

As used herein, the term “substantially” may be taken to represent the inherent degree of uncertainty that may be attributed to any quantitative comparison, value, measurement, or other representation. Thus, the term substantially may mean an amount of generally at least about 80%, about 90%, about 95%, about 98%, or even about 99% of a stated value.

It must also be noted that as used herein and in the appended claims, the singular forms “a,” “an,” and “the” include the plural reference unless the context clearly dictates otherwise. Thus, for example, reference to “a” sprayer, “an” attachment element, or “the” wash unit is a reference to one or more sprayers, attachment elements, or wash units and equivalents thereof known to those skilled in the art, and so forth. Unless defined otherwise, all technical and scientific terms used herein have the same meanings as commonly understood by one of ordinary skill in the art.

Words such as “then,” “next,” etc. are not intended to limit the order of the steps; these words are simply used to guide the reader through the description of the methods.

A list of the various elements shown in the drawings is provided in the table below.

| Reference | |
|---|---|
| Number | Element |
| 1, 2 | Garage door tracks |
| 3 | Garage door |
| 4 | Vehicle (car) |
| 5a, 5b | Wash sprayers of wash unit 13a |
| 6a, 6b | Wash sprayers of wash unit 13b |
| 7 | Underbody sprayer |
| 8 | Spay nozzles of the underbody sprayer 7 |
| 9 | Quick connect to wash sprayers 5a-6b |
| 10a | Wheel wash component |
| 10b | Scrub brush component |
| 11, 12 | Wash unit tracks |
| 11′, 12′ | Wash unit tracks |
| 13a, 13b | Wash units |
| 14 | Motor of wheel wash component 10a |
| 15 | Circulating wash pad of component 10a |
| 16 | Scrub brush of component 10b |
| 17a, 17b | Legs of wash frame 22 |
| 18 | Wheels of wash frame 22 |
| 19a, 19b | Lateral supports of wash frame 22 |
| 20a, 20b | Base rails of wash unit 22′ |
| 21 | Garage floor |
| 22, 22′, 22″ | Wash system |

What is claimed is:

1. A car wash system configured for installation in a residential or commercial building, the apparatus comprising:
at least one track configured for attachment to an interior surface of the residential building; and
one or more wash units moveably connected to the track.

2. The system of claim 1, for use in a garage of the residential or commercial building, wherein the interior surface comprises a ceiling, a front and back wall, a side wall, a floor, or a front or back wall and a ceiling.

3. The system of claim 1, wherein each of the one or more wash units comprise one or more wash apparatus, wherein the one or more wash apparatus comprise a flexible hose or an articulate pipe.

4. The system of claim 3, wherein each of the one or more wash apparatus comprise a retracted position and an extended position.

5. The system of claim 1, wherein the at least one track comprises a telescoping arm configured to extend to a position outside of the residential or commercial building, and wherein the one or more wash units are configured to move along the at least one track to a position outside of the residential or commercial building.

6. The system of claim 1, wherein the one or more wash units comprise a passive position and an active position.

7. The system of claim 6, wherein the one or more wash units rotate on the at least one track from the passive position to the active position.

8. The system of claim 1, comprising a component attachable to an end of the one or more wash apparatus.

9. The system of claim 8, wherein the component comprises an underbody sprayer or a wheel and rim scrubber.

10. The system of claim 1, wherein the wash units provide touchless cleaning of a vehicle.

11. A car wash system configured for use in a residential or commercial building, the apparatus comprising:
a frame having at least four vertical posts supporting an upper frame, each post comprises a bottom end having a wheel and a top end attached to and supporting the upper frame; and
one or more wash units moveably connected to the upper frame and configured to provide a wash fluid directed inward from opposing vertical sides of the frame,
wherein the apparatus is sized and configured to accept a vehicle within the frame.

12. The system of claim 11, wherein the at least four vertical posts are adjustable in length to change a height of the upper frame relative to a ground surface.

13. The system of claim 11, wherein the upper frame comprises longitudinal rails that are adjustable in length to change a longitudinal length of the frame, lateral rails that are adjustable in length to change a lateral width of the frame, or both.

14. The system of claim 11, wherein each of the one or more wash units comprise one or more wash apparatus.

15. The system of claim 14, wherein each of the one or more wash apparatus comprise a retracted position and an extended position.

16. The system of claim 1, wherein each of the one or more wash units comprise one or more wash apparatus, wherein the one or more wash apparatus comprise a flexible hose or an articulate pipe.

17. The system of claim 11, wherein the one or more wash units comprise a passive position and an active position.

18. The system of claim 17, wherein the one or more wash units rotate on the upper frame from the passive position to the active position.

19. The system of claim 11, comprising a component attachable to an end of the one or more wash hoses.

20. The system of claim 19, wherein the component comprises an underbody sprayer or a wheel and rim scrubber.
